(19) United States
(12) Patent Application Publication
(10) Pub. No.: US 2026/0031692 A1
(43) Pub. Date: Jan. 29, 2026

(54) INDUCTION MACHINE ROTOR AND METHOD OF MAKING

(71) Applicant: FCA US LLC, Auburn Hills, MI (US)

(72) Inventors: Reemon Haddad, Auburn Hills, MI (US); Dhafar Al-Ani, Auburn Hills, MI (US)

(21) Appl. No.: 18/787,040

(22) Filed: Jul. 29, 2024

(51) Int. Cl. H02K 17/16; H02K 15/00

(52) U.S. Cl. CPC H02K 17/168; H02K 15/023; H02K 2215/00

(57) ABSTRACT

A rotor assembly is configured to rotate relative to a stator to drive a rotor shaft and at least one drive wheel of an electric vehicle. The rotor assembly includes a rotor core, and first and second bar assemblies. The rotor core includes a core body that defines a plurality of circumferentially arranged bar passages including a plurality of first bar passages and a plurality of second bar passages. The first bar assembly includes a plurality of first bars, each of the first bars having a first elongated blade portion and a first end body portion. The second bar assembly includes a plurality of second bars, each of the second bars having a second elongated blade portion and a second end body portion. the first bars and the second bars are alternately received at the respective plurality of first bar passages and second bar passages in the core body.

### FIELD

The present application relates generally to induction machines and more particularly to a rotor assembly for a squirrel-cage induction machine and method of making same.

### BACKGROUND

Different types of electric vehicles, including mild hybrid electric vehicles (mHEV's), plug-in hybrid electric vehicles (PHEV's), battery electric vehicles (BEV's), and range extended battery electric vehicles (REEV's), rely on electric machines for propulsion as a main source of torque, which generates the necessary power for vehicle propulsion. One type of electric machine is an induction machine (IM) or an asynchronous machine that operates based on the principles of electromagnetic induction. IM's generally come in two configurations, a squirrel-cage rotor and a wound rotor. A squirrel-cage rotor includes bars or rods made of electrically conducting materials, typically aluminum or copper, or any other alloy that are positioned radially in the rotor core. These bars are arranged in a parallel relationship to the IM shaft and are evenly spaced radially around the circumference of the rotor. The conductive bars are connected at each end by short-circuiting rings, creating a closed-loop circuit. Known methods for assembling squirrel-cage rotors can require significant manufacturing time, complexity, number of components and cost. In this regard, while existing squirrel cage rotor configurations can be satisfactory, there remains a need for improvement in the relevant art.

### SUMMARY

In accordance with one example aspect of the invention, an electric machine for powering an electric vehicle includes a rotor assembly configured to rotate relative to a stator to drive a rotor shaft and at least one drive wheel of the electric vehicle. The rotor assembly includes a rotor core, a first bar assembly and a second bar assembly. The rotor core includes a core body that defines a plurality of circumferentially arranged bar passages including a plurality of first bar passages and a plurality of second bar passages. The first bar assembly includes a plurality of first bars, each of the first bars having a first elongated blade portion and a first end body portion. The second bar assembly includes a plurality of second bars, each of the second bars having a second elongated blade portion and a second end body portion. the first bars and the second bars are alternately received at the respective plurality of first bar passages and second bar passages in the core body. A first end ring comprises alternating and electrically joined second elongated blades and first end body portions. A second end ring comprises alternative and electrically joined first elongated blades and second end body portions.

In examples, the first end body portion comprises a first outer body portion and a second inner body portion, the first outer body portion including first outer flanges, the first inner body portion defining first inner flanges.

In examples, the first end body portion defines first outer slots between respective first outer flanges and first inner flanges.

In other examples, the second end body portion comprises a second outer body portion and a second inner body portion, the second outer body portion including second outer flanges, the second inner body portion defining second inner flanges.

In other implementations, the second end body portion defines second outer slots between respective second outer flanges and second inner flanges.

In examples, the first end body portions receive adjacent second elongated blades at the first outer slots.

In other examples, the second end body portions receive adjacent first elongated blades at the second outer slots.

In additional implementations, the first end body portions define fingers at the first outer slots that are configured to receive grooves defined along the second elongated blade portion.

According to an example aspect of the invention, a method is provided for forming an electric machine for powering an electric vehicle, the electric machine having a rotor assembly configured to rotate relative to a stator to drive a rotor shaft and at least one drive wheel of the electric vehicle. The method includes: providing a rotor core having a core body that defines a plurality of circumferentially arranged bar passages including a plurality of first bar passages and a plurality of second bar passages; inserting a first bar assembly into the plurality of first bar passages, the first bar assembly having a plurality of first bars, each of the first bars having a first elongated blade portion and a first end body portion; inserting a second bar assembly into the plurality of second bar passages, the second bar assembly having a plurality of second bars, each of the second bars having a second elongated blade portion and a second end body portion, wherein the first bars and the second bars are alternately received at the respective plurality of first bar passages and second bar passages in the core body; joining adjacent second elongated blades and first end body portions to create an electrically conductive first end ring; and joining adjacent first elongated blades and second end body portions to create an electrically conducting second end ring.

In examples of the method, the joining comprises welding.

In other examples of the method, the joining comprises induction heating.

In additional examples of the method, the first end body portion comprises a first outer body portion and a second inner body portion, the first outer body portion including first outer flanges, the first inner body portion defining first inner flanges.

In other examples of the method, the first end body portion defines first outer slots between respective first outer flanges and first inner flanges.

In additional examples of the method, the second end body portion comprises a second outer body portion and a second inner body portion, the second outer body portion including second outer flanges, the second inner body portion defining second inner flanges.

In other examples of the method, the second end body portion defines second outer slots between respective second outer flanges and second inner flanges.

In additional examples of the method, the first end body portions receive adjacent second elongated blades at the first outer slots.

In other examples of the method, the second end body portions receive adjacent first elongated blades at the second outer slots.

In additional examples of the method, the first end body portions define fingers at the first outer slots that are configured to receive grooves defined along the second elongated blade portion.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example electric vehicle drivetrain having an electric drive module that incorporates a squirrel-cage induction motor rotor assembly, in accordance with the principles of the present application;

FIG. 2 is a front perspective view of the squirrel-cage induction motor rotor assembly shown in FIG. 1, in accordance with the principles of the present application;

FIG. 3 is perspective view of a first exemplary rotor bar or rod, in accordance with the principles of the present application;

FIG. 4 is an exploded perspective view of the squirrel-cage induction motor rotor assembly of FIG. 2 shown during a first assembly step wherein a first bar assembly is positioned adjacent a first axial end of a rotor core and a second bar assembly is positioned adjacent a second, opposite axial end of the rotor core according to examples of the present application;

FIG. 5A is an exploded perspective view of the squirrel-cage induction motor rotor assembly of FIG. 4 shown during a second assembly step wherein the first bar assembly is inserted to corresponding first slots arranged at the first axial end of the rotor core according to examples of the present application;

FIG. 5B is a section view along line 5B-5B of the assembled squirrel-cage induction motor rotor assembly of FIG. 2;

FIG. 6 is a detailed perspective view of three connected bars of the first bar assembly; and

FIG. 7 is a detailed perspective view of a bar constructed in accordance with additional features of the present application.

### DETAILED DESCRIPTION

As noted above, a squirrel-cage rotor includes bars or rods (hereinafter “bars”) made of electrically conducting materials, such as aluminum or copper, that are positioned radially in the rotor core. These bars are arranged in a parallel relationship to the IM shaft and are evenly spaced radially around the circumference of the rotor. The conductive bars are connected at each end by short-circuiting rings, creating a closed-loop circuit. The creation of rotor bars in an IM encompasses a diverse array of methods, each offering unique advantages and considerations related to the specific requirements of the electric machine. Factors such as IM design, intended application, manufacturing processes, and desired performance characteristics all influence the selection of the most suitable method. However, regardless of the chosen approach, the complex nature of the manufacturing process poses a significant challenge, impacting both cost and time. In the context of IM's, an optimized manufacturing process is crucial for minimizing overall costs and reducing production time while upholding design quality.

The creation of rotor bars historically can involve one or more combinations of die-casting, extrusion, forging, machining and/or casting. In die-casting, molten metal, often aluminum or copper is injected into molds to create the rotor bars and end rings. Extrusion involves forcing metal through a shaped die to create continuous lengths of rotor bars. These bars can then be cut to the required lengths and bent to match the rotor core's curvature. Extrusion can be difficult with intricate shapes or profiles provided on some bar geometries. Certain materials may not be suitable for extrusion, limiting material options. Initial tooling costs for dies can be high, particularly for custom shapes or sizes.

Forging involves shaping metal by applying compressive force. Forging produces strong and durable rotor bars with precise dimensions but may be more time-consuming and expensive compared to other methods. The forging process typically generates more material waste compared to other methods. Setting up forging equipment and dies can be expensive, particularly for small production runs. Forging is better suited for simpler shapes. Complex geometries can be challenging using forging techniques.

Machining involves removing material from a solid block to create the desired shape of the rotor bars. Machining offers high precision and flexibility but may be less efficient for mass production compared to other methods. Significant material is removed during machining, leading to higher costs and waste. Machining individual rotor bars can be time-consuming, especially for large-scale production. Continuous machining can lead to tool wear and require frequent tool changes, impacting productivity.

Casting involves pouring molten metal into molds to create the rotor bars and the end rings. Casting is suitable for producing complex shapes and larger induction machines. Casting can be unfavorable due to dimensional accuracy. In this regard, achieving precise dimensions can be challenging, leading to variations in size. Furthermore, cast surfaces may require additional finishing processes to achieve the desired smoothness. Additionally, trapped air or gas pockets in the casting can compromise the integrity of the rotor bars.

According to the principles of the present application, a squirrel-cage IM rotor and method for assembling is provided. The rotor bar shape is modified. A first plurality of rotor bars are coupled creating a first bar assembly. A second plurality of rotor bars are coupled creating a second bar assembly. The first and second bar assemblies are inserted into the rotor core from opposite axial ends. A welding process (laser welding, induction heating, etc.) is applied to create respective first and second end rings on the first and second bar assemblies. The squirrel-cage IM rotor disclosed herein is advantageous as a single shape for the bars is required for the assembly, reducing the manufacturing assembly time, complexity and cost compared to the conventional assembly methods of prior art squirrel-cage IM's. While a couple exemplary bar geometries are discussed below, the concepts disclosed herein are adaptable to any rotor bar shape.

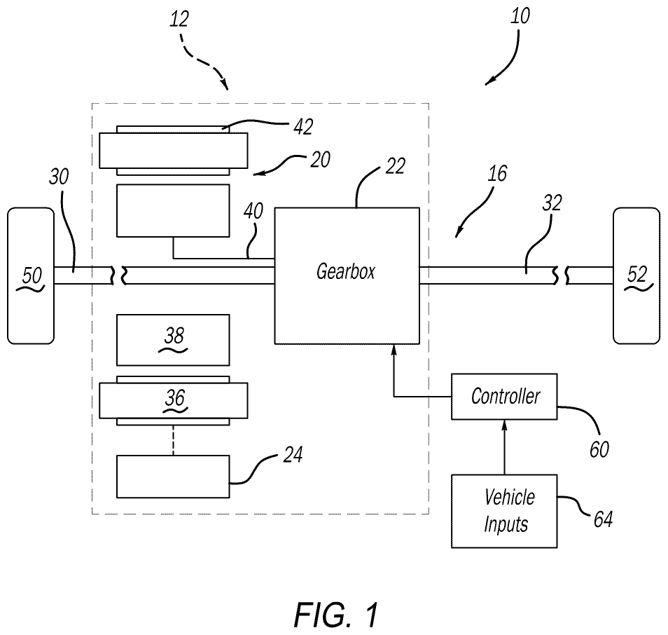

With initial reference to FIG. 1, a vehicle 10 is partially shown in accordance with the principles of the present disclosure. In the example embodiment, vehicle 10 includes an electric drive module (EDM) 12 configured to generate and transfer drive torque to a driveline 16 for vehicle propulsion. The EDM 12 generally includes one or more electric drive units or machines 20 (e.g., electric traction machines), a gearbox assembly 22, and power electronics including a power inverter module (PIM) 24. The electric machine 20 is selectively connectable via the PIM 24 to a high voltage battery system (not shown) for powering the electric machine 20. The gearbox assembly 22 is configured to transfer the generated drive torque to the driveline 16, including a first or left axle shaft 30 configured to drive a left wheel 50 and a second or right axle shaft 32 configured to drive a right wheel 52. In the example shown, the EDM 12 is configured for use on a rear axle of a two-wheel drive vehicle. It is appreciated however that the EDM 12 can be alternatively configured for use on a front axle of a two-wheel drive vehicle. In other examples an EDM 12 can be provided on both of the front and rear axles for a four-wheel drive or all-wheel drive driveline vehicle. In the example embodiment, the electric machine 20 generally includes a stator 36, a rotor assembly 38 and a rotor output shaft 40. It will be appreciated that while the exemplary vehicle 10 is configured as an electric vehicle, the electric machine 20 can be suitable for use with other vehicle configurations that have electric machines 20 including those that also employ other supplemental drive sources (e.g., hybrid vehicles that also include internal combustion engines, etc.).

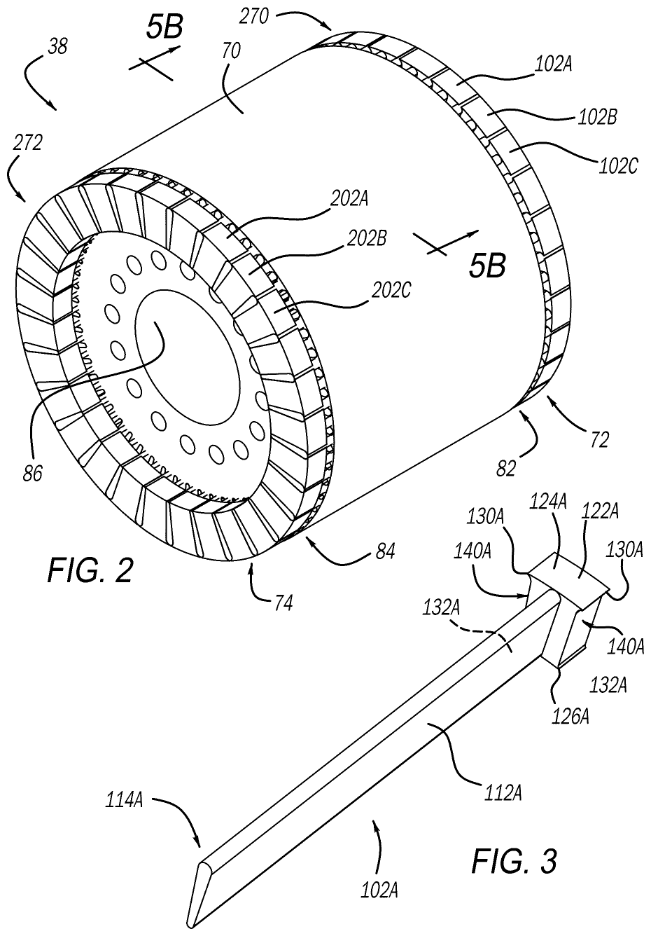

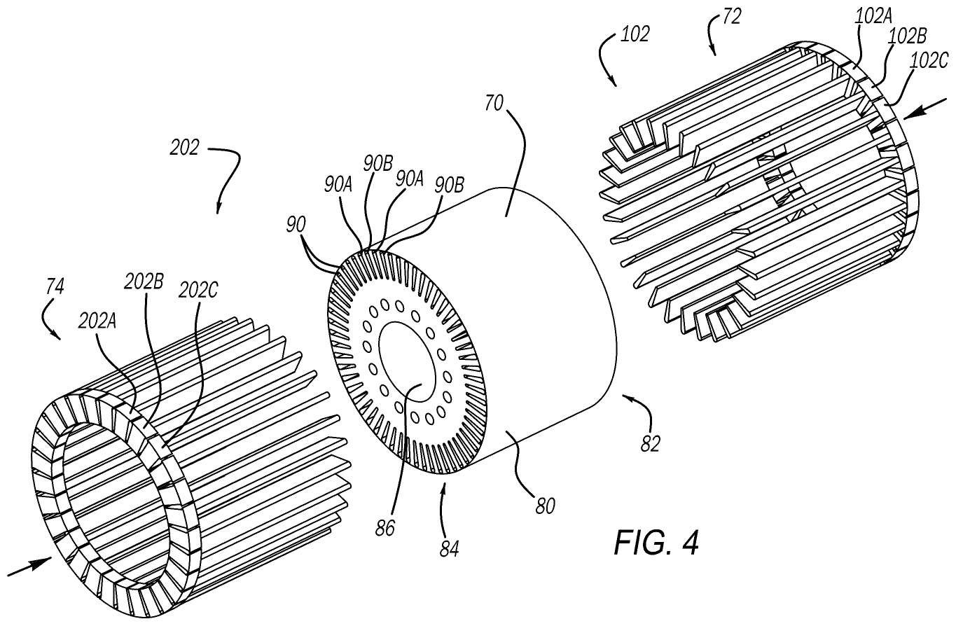

With additional reference now to FIGS. 2-4, the rotor assembly 38 constructed in accordance to one example of the present disclosure will be described. The rotor assembly 38 generally comprises a rotor core 70, a first bar assembly 72 and a second bar assembly 74. The rotor core 70 generally comprises a core body 80 that extends between a first axial end 82 and a second axial end 84. The core body 80 defines a central passage 86 for receiving the rotor output shaft 40. A plurality of bar passages, collectively identified at reference numeral 90, are defined circumferentially through the core body 80. The plurality of bar passages 90 are referred to herein as first bar passages 90A and second bar passages 90B. In this example described, bar passages of the first bar passages 90A are alternatively arranged between bar passages of the second bar passages 90B. It will be appreciated that all bar passages 90 are formed similarly.

The first bar assembly 72 includes a plurality of first bars, collectively identified at reference numeral 102, that are circumferentially arranged. The first bars 102 are individually identified at reference numerals 102A, 102B, 102C, etc. While 29 bars are shown, it will be appreciated that other quantities may be implemented within the scope of the present disclosure. Similarly, the second bar assembly 74 includes a plurality of second bars, collectively identified at reference numeral 202, that are circumferentially arranged. The second bars 202 are individually identified at reference numerals 202A, 202B, 202C, etc. While 29 bars are shown, it will be appreciated that other quantities may be implemented within the scope of the present disclosure.

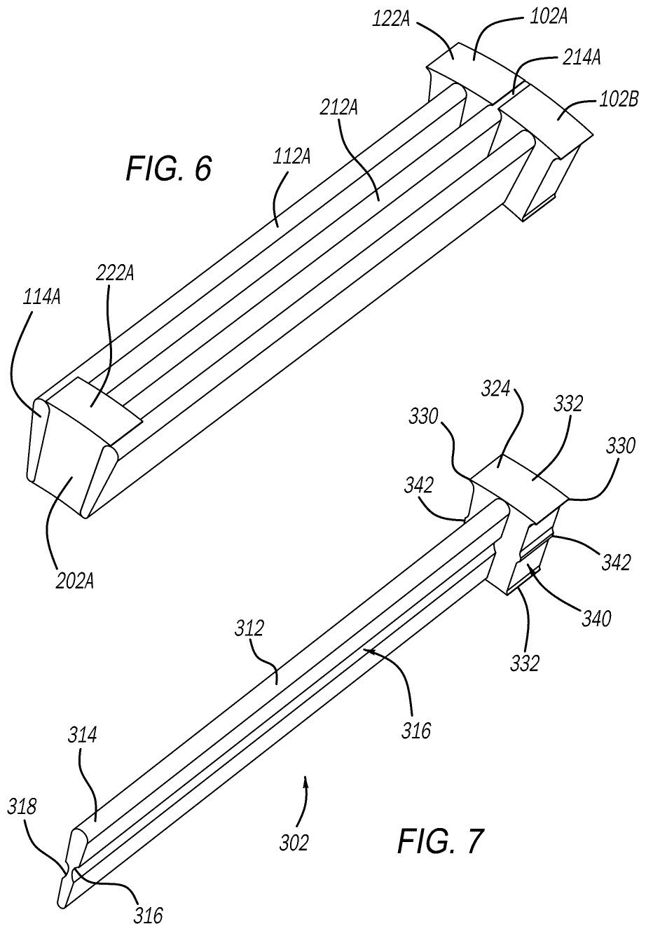

With particular reference to FIG. 3, the first bar 102A will be described with the appreciation that all of the first bars 102 and second bars 202 are similarly formed. As such, like features of the second bars 202 are shown in the FIGS using like reference numerals of the first bars 102 and increased by 100. The first bar 102A includes an elongated blade portion 112A and an end body portion 122A. The elongated blade portion 112A terminates at an opposite end of the end body portion 112A at a distal end 114A. The end body portion 122A generally includes an outer body portion 124A and an inner body portion 126A. The outer body portion 124A includes outer flanges 130A. The inner body portion 126A includes inner flanges 132A. The end body portion 122A defines outer slots 140A between respective outer flanges 130A and inner flanges 132A. As will become appreciated herein, the outer slots 140A are dimensioned to nestingly receive ends 214 of a bar 202A from the plurality of second bars 202 (FIG. 6).

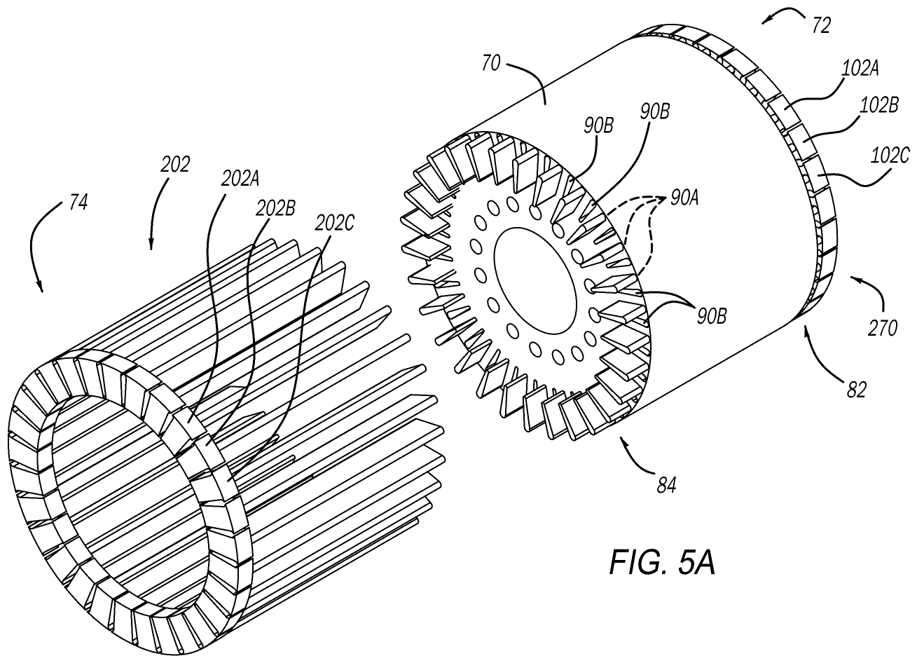

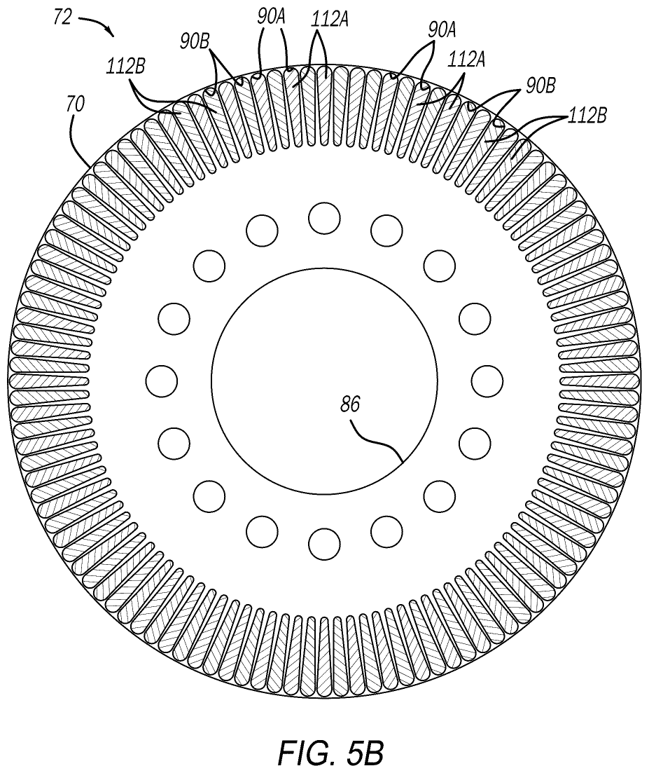

Turning now to FIGS. 5A-5B, the plurality of first bars 102 are shown inserted into the respective first bar passages 90A. It will be appreciated that the plurality of first bars 102 are not necessarily coupled to each other. In this regard, they can be individually inserted or collectively inserted into the respective bar passages 90A. Next, the plurality of second bars 202 can then be inserted into the respective second bar passages 90B. It is appreciated that the bars 102 of the plurality of first bars 102 alternate with the bars 202 of the plurality of second bars 202 in the installed position (FIGS. 2 and 5B). Once all of the plurality of first and second bars 102, 202 are inserted, a joining technique is used (such as welding including laser welding, induction heating, or other joining technique that electrically couples adjacent bars 102 and 202 together) forming a first end ring connection 270 at the first axial end 82 of the rotor core 70 and a second end ring connection 272 at the second axial end 84 of the rotor core 70.

The first end ring connection 270 is collectively defined by end body portions 122A of the plurality of first bars 102A and alternating distal ends 214A of the plurality of second bars 202A. Similarly, the second end ring connection 272 is collectively defined by end body portions 222A of the plurality of second bars 202A and alternating distal ends 114A of the plurality of first bars 102A.

With particular reference to FIG. 7, a third bar 302 constructed in accordance to additional features of the instant disclosure will be described. The third bar 302 includes an elongated blade portion 312 and an end body portion 322. The elongated blade portion 312 terminates at an opposite end of the end body portion 312 at a distal end 314. The elongated blade portion 312 defines grooves 316, 318. The end body portion 322 generally includes an outer body portion 324 and an inner body portion 326. The outer body portion 324 includes outer flanges 330. The inner body portion 326 includes inner flanges 332. The end body portion 322 defines outer slots 340 between respective outer flanges 330 and inner flanges 332. Fingers 342 are formed at the slots 340. The fingers 342 are configured in a geometry to locate respective grooves (316, 318) of adjacent bars in an assembled condition as described above. It will be appreciated that other geometries can be employed.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An electric machine for powering an electric vehicle, the electric machine comprising:
a rotor assembly configured to rotate relative to a stator to drive a rotor shaft and at least one drive wheel of the electric vehicle, the rotor assembly comprising:
a rotor core having a core body that defines a plurality of circumferentially arranged bar passages including a plurality of first bar passages and a plurality of second bar passages;
a first bar assembly having a plurality of first bars, each of the first bars having a first elongated blade portion and a first end body portion;
a second bar assembly having a plurality of second bars, each of the second bars having a second elongated blade portion and a second end body portion;
wherein the first bars and the second bars are alternately received at the respective plurality of first bar passages and second bar passages in the core body;
a first end ring comprising alternating and electrically joined second elongated blades and first end body portions; and
a second end ring comprising alternative and electrically joined first elongated blades and second end body portions.

2. The electric machine of claim 1, wherein the first end body portion comprises a first outer body portion and a second inner body portion, the first outer body portion including first outer flanges, the first inner body portion defining first inner flanges.

3. The electric machine of claim 2, wherein the first end body portion defines first outer slots between respective first outer flanges and first inner flanges.

4. The electric machine of claim 3, wherein the second end body portion comprises a second outer body portion and a second inner body portion, the second outer body portion including second outer flanges, the second inner body portion defining second inner flanges.

5. The electric machine of claim 4, wherein the second end body portion defines second outer slots between respective second outer flanges and second inner flanges.

6. The electric machine of claim 5, wherein the first end body portions receive adjacent second elongated blades at the first outer slots.

7. The electric machine of claim 6, wherein the second end body portions receive adjacent first elongated blades at the second outer slots.

8. The electric machine of claim 7, wherein the first end body portions define fingers at the first outer slots that are configured to receive grooves defined along the second elongated blade portion.

9. A method of forming an electric machine for powering an electric vehicle, the electric machine having a rotor assembly configured to rotate relative to a stator to drive a rotor shaft and at least one drive wheel of the electric vehicle, the method comprising:
providing a rotor core having a core body that defines a plurality of circumferentially arranged bar passages including a plurality of first bar passages and a plurality of second bar passages;
inserting a first bar assembly into the plurality of first bar passages, the first bar assembly having a plurality of first bars, each of the first bars having a first elongated blade portion and a first end body portion;
inserting a second bar assembly into the plurality of second bar passages, the second bar assembly having a plurality of second bars, each of the second bars having a second elongated blade portion and a second end body portion, wherein the first bars and the second bars are alternately received at the respective plurality of first bar passages and second bar passages in the core body;
joining adjacent second elongated blades and first end body portions to create an electrically conductive first end ring; and
joining adjacent first elongated blades and second end body portions to create an electrically conducting second end ring.

10. The method of claim 9, wherein the joining comprises welding.

11. The method of claim 9, wherein the joining comprises induction heating.

12. The method of claim 9, wherein the first end body portion comprises a first outer body portion and a second inner body portion, the first outer body portion including first outer flanges, the first inner body portion defining first inner flanges.

13. The method of claim 12, wherein the first end body portion defines first outer slots between respective first outer flanges and first inner flanges.

14. The method of claim 13, wherein the second end body portion comprises a second outer body portion and a second inner body portion, the second outer body portion including second outer flanges, the second inner body portion defining second inner flanges.

15. The method of claim 14, wherein the second end body portion defines second outer slots between respective second outer flanges and second inner flanges.

16. The method of claim 15, wherein the first end body portions receive adjacent second elongated blades at the first outer slots.

17. The method of claim 16, wherein the second end body portions receive adjacent first elongated blades at the second outer slots.

18. The method of claim 17, wherein the first end body portions define fingers at the first outer slots that are configured to receive grooves defined along the second elongated blade portion.
